(19) United States
(12) Patent Application Publication
(10) Pub. No.: US 2009/0053508 A1
(43) Pub. Date: Feb. 26, 2009

(54) Method for producing a partially shaped electrically conductive structure

(76) Inventors: Walter Lehnberger, Treuchtlingen (DE); Heinrich Wild, Herzogenaurach (DE)

Correspondence Address: Charles R. Hoffmann;Hoffmann & Baron, 6900 Jericho Turnpike, Syosset, NY, 11791, US

(21) Appl. No.: 11/918,815

(22) PCT Filed: Apr. 26, 2006
(86) PCT No.: PCT/EP2006/003840

§ 371 Date: Dec. 17, 2007

(30) Foreign Application Priority Data
Apr. 27, 2005 (DE) 10 2005 019 920.8

(51) Int. Cl. B32B 5/16; B05D 5/12

(52) U.S. Cl. 428/328; 427/58; 427/126.1; 428/323

(57) ABSTRACT

There is described a process for the production of a partially shaped electrically conductive structure on a carrier substrate (16), wherein it is provided that a latent magnetic image of the graphic form of the electrically conductive structure, which latent magnetic image is formed from magnetic image points (11m) and non-magnetic image points, is produced from a digital data set which defines the graphic form of the electrically conductive structure on a magnetisable printing form (11), and that by means of the printing form (11) magnetic particles having an electrically conductive surface, which are attracted by the magnetic image points are arranged by the lateral magnetic image to afford the graphic form of the electrically conductive structure on the carrier substrate (16) and are fixed there. A multi-layer body produced with that process is further described.

The invention concerns a process for the production of a partially shaped electrically conductive structure on a carrier substrate, and a multi-layer body produced with that process.

For the production of partially shaped electrically conductive structures on a carrier substrate it is known for a dispersion which contains iron particles to be applied to the carrier substrate, for example a carrier film, by means of intaglio printing, screen printing or flexographic printing.

A disadvantage with that process is that the iron particle-bearing dispersion causes a large amount of wear at all components of the printing machine such as raster screen rollers, screens or flexographic printing blocks, which come into contact therewith. A further disadvantage is that changes to the graphic shape of the electrically conductive structure require tool changes which are time-consuming and/or expensive.

The object of the present invention is to provide an improved process for the production of a partially shaped electrically conductive structure on a carrier substrate as well as an improved multi-layer body having such an electrically conductive structure.

In accordance with the invention that object is attained by a process for the production of a partially shaped electrically conductive structure on a carrier substrate, in which it is provided that a latent magnetic image of the graphic form of the electrically conductive structure, which latent magnetic image is formed from magnetic image points and non-magnetic image points, is produced from a digital data set: which defines the graphic form of the electrically conductive structure on a magnetisable printing form, and that by means of the printing form magnetic particles having an electrically conductive surface, which are attracted by the magnetic image points, are arranged by the latent magnetic image to afford the graphic form of the electrically conductive structure on the carrier substrate and are fixed there.

The object is further attained by a multi-layer body having a partially shaped electrically conductive structure, wherein it is provided that the multi-layer body has a layer of magnetic particles having an electrically conductive surface, which are arranged in the graphic form of the electrically conductive structure.

The process according to the invention saves on time and cost. It makes it possible to implement changes in the graphic form of the partially shaped electrically conductive structure, at a low level of complication and expenditure. It can be provided that the digital data set in respect of the graphic form of the electrically conductive structure is produced by a digital imaging process, for example by means of an electronic camera or a scanner, or that the digital data set is produced with a computer-aided design program.

The digital data set can comprise digital image points which can involve the binary value ‘1’ or ‘0’, wherein the binary value ‘1’ embodies an image point which is associated with the graphic form of the electrically conductive structure and the binary value ‘0’ embodies an image point which is not associated with the graphic form of the electrically conductive structure.

It can be provided that the digital data set is provided for further use in a computer.

The process according to the invention is distinguished by high speed, low costs, a high level of flexibility and a long service life for the printing form. No wear occurs at the components which are relevant for the printing result such as for example on raster screen rollers, screens or flexographic printing blocks of conventional printers.

Numerous copies can be produced from a printing form described with a latent magnetic image, with the print quality remaining the same. The process according to the invention is therefore particularly suitable for producing mass-produced products with partially shaped electrically conductive structures.

The multi-layer body according to the invention can be produced with further layers, for example with optical and/or electrical functional layers. Besides the function of forming a carrier layer for producing the partially shaped electrically conductive structure, the magnetic particles can at least portion-wise perform a further function, for example as a magnetic code layer. The invention provides that it is possible to produce in a multi-layer body antennae, coils and capacitors as well as electronic units, for example units in polymer electronics, in which the electrically conductive structure can be for example in the form of connecting lines, electrode layers or the like.

Further advantageous configurations are set forth in the appendant claims.

It can advantageously be provided that the multi-layer body is a carrier film which is supplied and processed in a roll-to-roll process.

It can be provided that the electrically conductive magnetic particles form the electrically conductive structure. For that purpose the particles must be arranged in closely packed relationship if the electrically conductive structure is to have a low resistance.

The electrically conductive magnetic particles can be formed from a soft-magnetic core and an electrically conducting casing so that the magnetic properties and the electrical properties of the magnetic particles can be optimised independently of each other.

In a further advantageous configuration it is therefore provided that the magnetic particles are electrically conductingly connected together by a first electrically conductive layer. That layer can be applied in the form of a metallic layer galvanically without an external current, using a reducing agent. Such a process is particularly suitable because it can be in the form of a continuous process. The process requires a bare metallic surface in respect of the magnetic particles, that is to say at least the upper portions of the magnetic particles must be exposed. For that purpose there are advantageously provided process steps which are further described hereinafter.

The first electrically conductive layer can be formed from copper or silver. It can preferably be provided that the first electrically conductive layer involves a layer thickness of between 40 nm and 70 nm.

It can advantageously be provided that the magnetic particles are provided at least at their surface with a material which is particularly well suited for being galvanised in a current-less procedure such as iron, copper, nickel, gold, tin, zinc or an alloy of those substances.

A further advantageous configuration provides that the first electrically conductive layer is reinforced by a second electrically conductive layer comprising a metal of low specific resistance such as aluminum, copper, nickel, silver or gold, which is applied galvanically with an external current. The electrical properties of that metallic layer can be adjusted within wide limits by the parameters of the galvanic procedure. If the magnetic particles already form an electrically conductive structure by virtue of their dense arrangement, it can be provided that the process dispenses with the application of the first electrically conductive layer and instead thereof the second electrically conductive layer is applied straightaway.

The electrically conductive structure generated by the process according to the invention can thus also be formed by the first and/or second electrically conductive layer.

It can preferably be provided that magnetic particles in flake form are used. It can also be provided that spherical magnetic particles are used. Spherical magnetic particles can be arranged in closely packed relationship independently of their rotary position in a sphere packing.

In a further advantageous configuration it is provided that magnetic particles of a diameter of between 2 μm and 10 μm are used, preferably of a diameter of between 2 μm and 4 μm.

It can further be provided that the same image resolution is selected for the digital data set and the latent magnetic image. The image points of the digital data set are therefore associated in 1:1 relationship with the magnetic image points on the printing form.

If the 1:1 association is not provided, it can preferably be provided that the quotient of the image resolution of the latent magnetic image and the image resolution of the digital data set or its reciprocal value are selected to be an integer. Modern image processing programs admittedly make it possible to select almost any quotients, but image transformation can lead to image defects which adversely affect the quality of shape of the structure to be produced. If for example the first image resolution involves 300 dpi (image points or dots per inch: 1 inch=25.4 mm) and the second image resolution involves 600 dpi, then the specified quotient is 2. Accordingly an image point of the digital data set is associated with four image points of the latent magnetic image if the same image resolution is provided both in the x-direction and also in the y-direction. With a quotient of 400/600 in contrast 1 image point of the digital data set is associated with 2.25 image points of the latent magnetic image. However only integral image points can be represented so that the latent magnetic image has an imaging defect.

The carrier substrate can have a primer layer to which the magnetic particles adhere. It can preferably be provided that the primer is applied with a layer thickness of between 3 and 4 μm.

It can be provided that magnetic particles in powder form are applied to the magnetised printing form and thus the latent magnetic image produced on the printing form is rendered visible, that is to say it is developed. Excess magnetic particles can be removed by being stripped off or sucked off. The magnetic particles can now be transferred on to the carrier substrate by the carrier substrate being brought into contact with the surface of the printing form. It can however also be provided that the magnetic particles in powder form are applied to the top side of the carrier substrate which is coated with primer, in which case the rear side of the carrier substrate is towards the top side of the printing form.

It can advantageously be provided that the carrier substrate is a carrier film which is some micrometers thick. By virtue of the small thickness of the carrier film the weakening effect in respect of the magnetic force exerted on the particles by the printing form, due to the gap produced by the carrier film between the particles and the printing form, is negligible.

A further advantageous configuration provides that a magnetic dispersion is used and the magnetic particles are applied in the form of the disperse phase of the dispersion. It is preferably provided that the proportion of the disperse phase to the dispersion is set at between 2 and 10% by weight.

In order to fix the magnetic particles on the primer it can be provided that the magnetic particles are pressed with a pressure roller into the surface of the primer. That manufacturing step can be facilitated if in that case the primer is heated and/or subjected to initial dissolution. If the magnetic particles are bound in a dispersion it is possible to provide a dispersing agent which provides for initial dissolution of the primer.

It can however also be provided that the magnetic dispersion is applied directly to the carrier substrate. As stated hereinbefore in relation to the application of magnetic particles in powder form, it can also be provided that the printing form is coated with the magnetic dispersion and the magnetic dispersion is then transferred on to the carrier substrate.

In a further configuration of the invention it can be provided that a carrier substrate coated with a magnetic dispersion, preferably a carrier film, is used, in which case the dispersing agent is initially dissolved or removed in order to render the magnetic particles which are fixed in the dispersion movable again. The magnetic particles are now oriented by the latent magnetic image of the printing form. Such pre-coating of the carrier substrate can be advantageous in order to arrange the magnetic particles in a particularly uniform and dense packing relationship on the carrier substrate.

It can also be provided that the magnetic particles are arranged on the carrier substrate in a magnetic layer involving the full surface area, which can be partially removed by means of a release layer. It can advantageously be provided in that case that the magnetic printing form is in the form of an endless circulating belt so that the relative speed between the carrier substrate and the printing form during release of the magnetic layer is equal to zero. The magnetic layer is detached in the regions which are not arranged over magnetic regions of the printing form. In that respect the adhesion force of the magnetic layer and the release layer is to be so selected that it is less than the magnetic adhesion force of the magnetic regions of the printing form.

For fixing the magnetic particles on the carrier substrate it can be provided that solvent is expelled from the primer and/or the dispersing agent or that the primer and/or the dispersing agent are melted on or that the primer and/or the dispersing agent are hardened off.

It can further be provided that the adhesion layer formed from the primer and/or the dispersing agent is formed with a layer thickness which is between 0.5 times and 1.5 times the mean diameter of the magnetic particles, preferably between 0.5 times and 0.8 times.

It can be provided that the upper portions of the magnetic particles are exposed prior to galvanic application of the first or the second electrically conducting layer respectively. For that purpose it is possible to use a solvent which initially dissolves the primer and/or the dispersing agent. Alternatively it can be provided that the upper portions of the magnetic particles are exposed by partial thermal removal of the primer and/or the dispersing agent. It is also possible to provide for mechanical removal which exposes the upper portions of the magnetic particles.

It can be provided that the adhesion layer in which the magnetic particles are fixed on the carrier substrate is of a layer thickness which is between 50% and 80% of the mean diameter of the magnetic particles. In that respect it can further be provided that the magnetic particles protrude from the adhesion layer by between 5% and 95% of the their mean diameter, preferably by between 40% and 60%.

The magnetisable printing form which is required for the above-described process can be in the form of a rotating printing cylinder or in the form of a circulating endless printing belt. Advantageously it is possible to provide an endless circulating printing belt because the carrier substrate which is supplied in a roll-to-roll process can form with the printing belt a contact surface in which the relative speed as between the carrier substrate and the printing belt is equal to zero. The same advantageous function can be implemented for a circulating printing drum if the carrier substrate extends around a portion of the printing drum.

In a further advantageous configuration it can be provided that the manufacturing apparatus intended for the process according to the invention is linked to further manufacturing apparatuses which are arranged upstream and/or downstream of the manufacturing apparatus. The carrier substrate can be for example a multi-layer film body having a plurality of optical and/or electrical functional layers. The multi-layer film body provided with an electrically conductive structure in the process according to the invention can now be completed in one or more following manufacturing stations with further layers for example to form a film circuit with optical security features.

The invention is now described in greater detail with reference to the drawings in which:

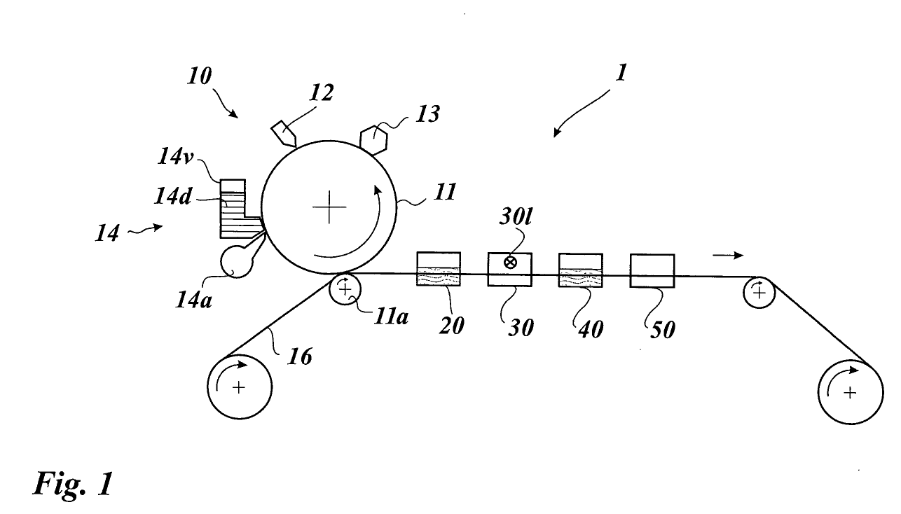

FIG. 1 is a diagrammatic view showing a first embodiment of a manufacturing station for carrying out the process according to the invention,

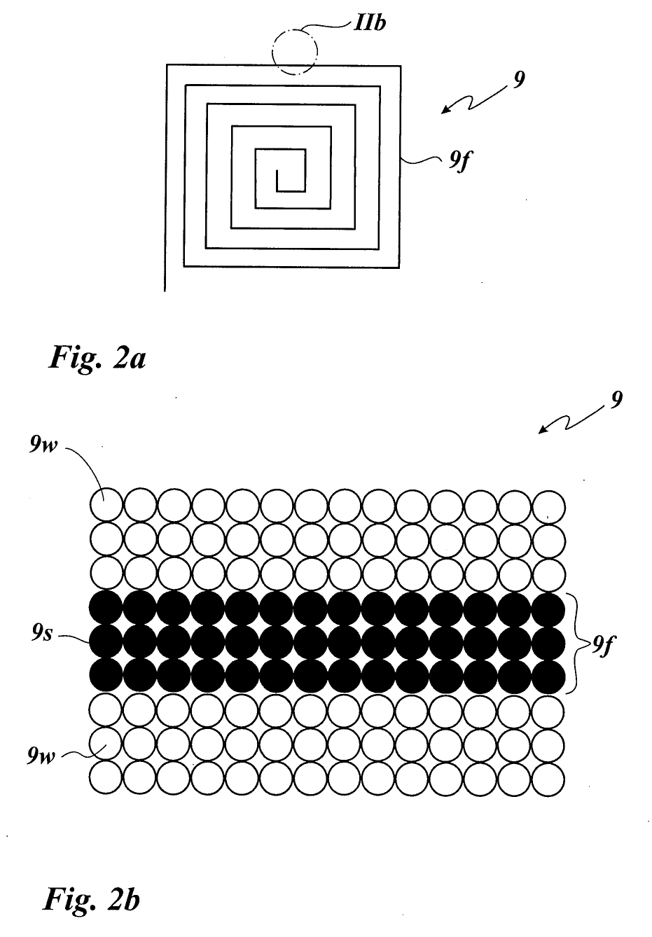

FIG. 2a shows an example of a digital image of a partially shaped electrically conductive structure,

FIG. 2b shows a detail IIb on an enlarged scale from FIG. 2a,

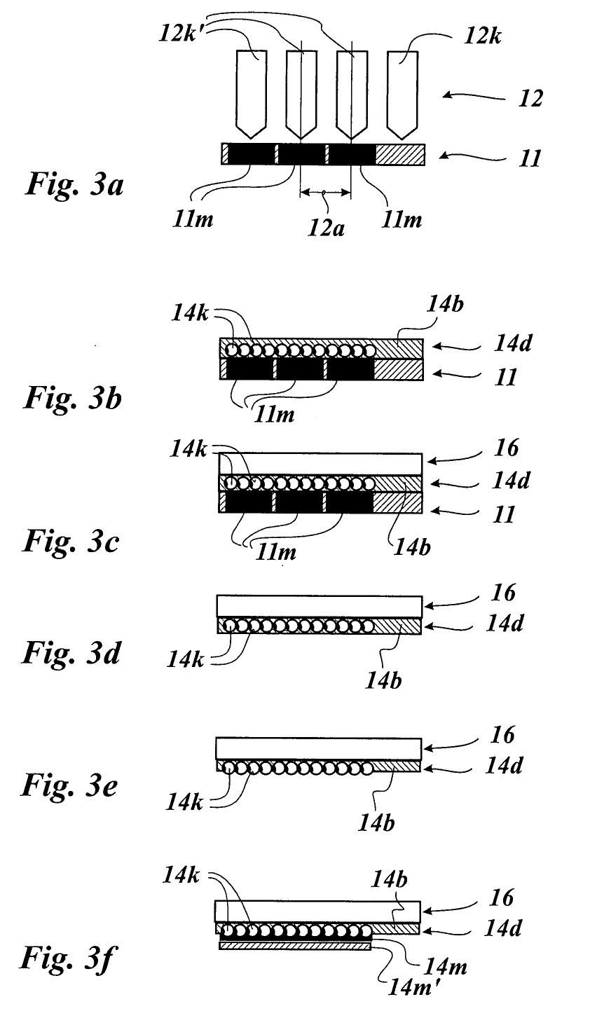

FIGS. 3a through 3f show diagrammatic views in section of the results of the process steps, which are achieved with the manufacturing station of FIG. 1,

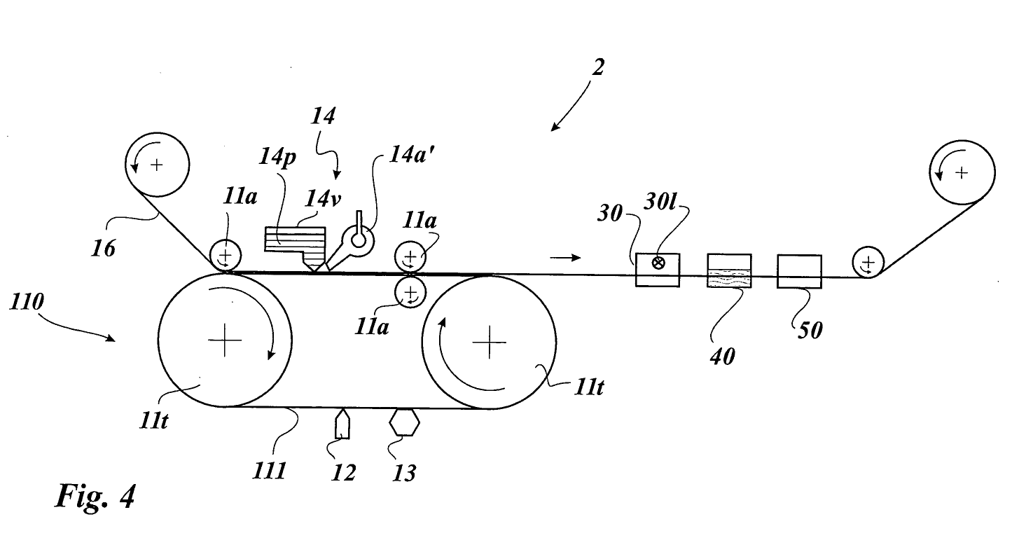

FIG. 4 shows a diagrammatic view of a second embodiment of a manufacturing station for carrying out the process according to the invention,

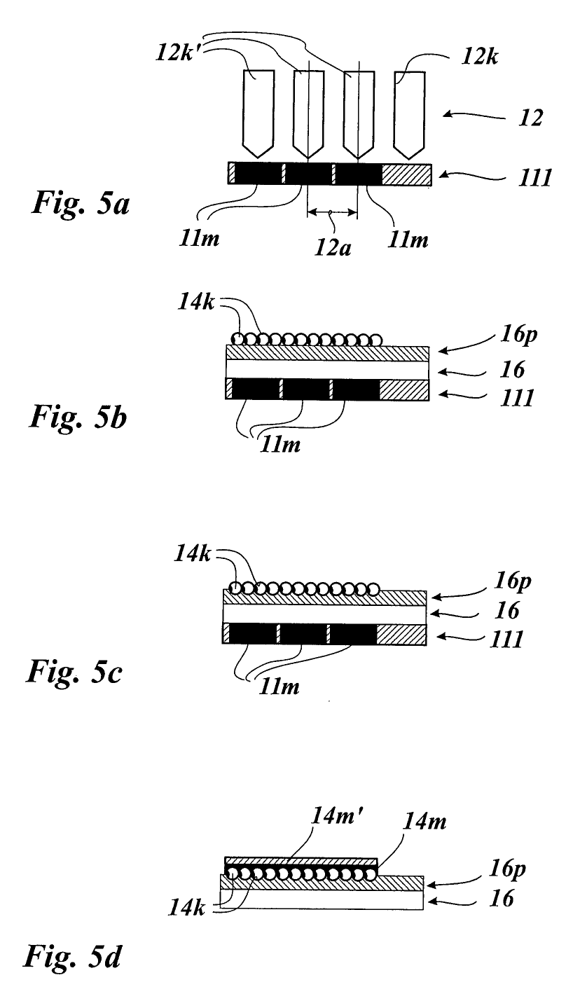

FIGS. 5a through 5d show diagrammatic views in section of the results of the process steps, which are achieved with the manufacturing station of FIG. 3,

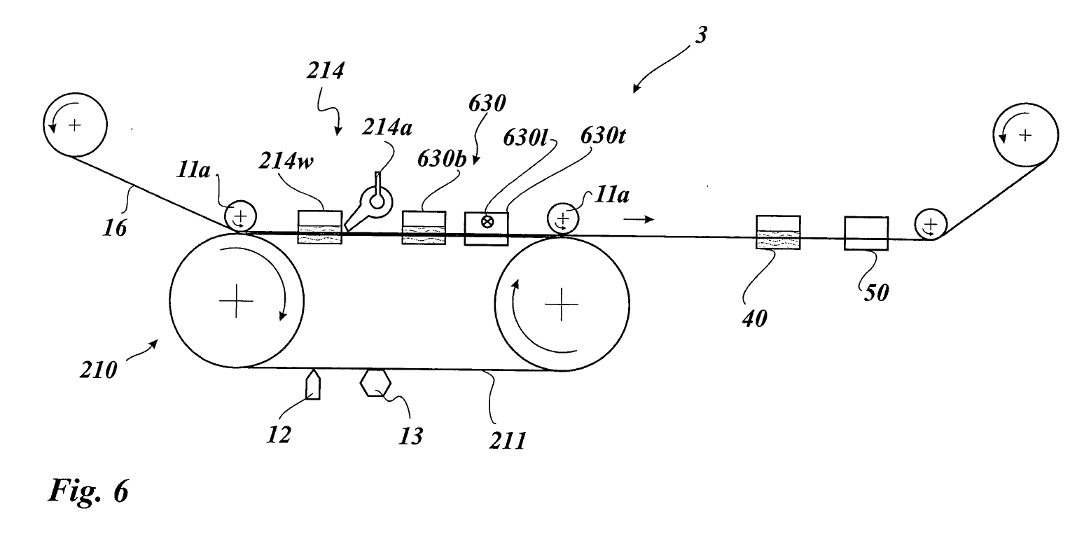

FIG. 6 shows a diagrammatic view of a third embodiment of a manufacturing station for carrying out the process according to the invention, and

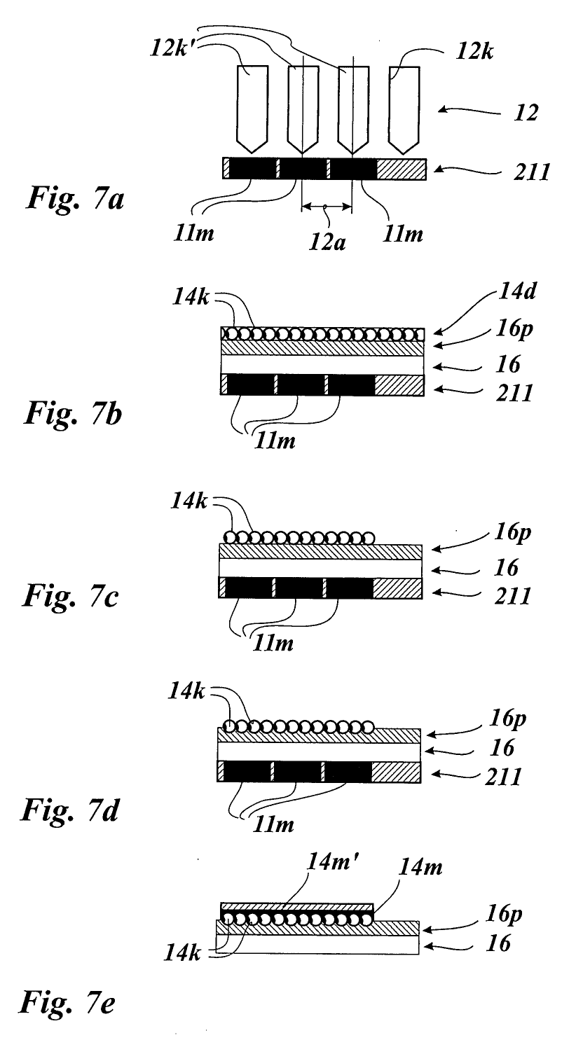

FIGS. 7a through 7e show diagrammatic views in section of the results of the process steps, which are achieved with the manufacturing station of FIG. 5.

FIG. 1 shows a manufacturing station 1 for carrying out the process according to the invention, comprising a printer 10, a washing station 20, a drying station 30, a galvanic bath 40 and a post-treatment station 50. FIGS. 3a through 3f show diagrammatic views of the results of the process steps, which are implemented with the manufacturing station 1.

FIGS. 2a and 2b, for better understanding, show a digital image 9 of a partially shaped electrically conductive structure 9f which, as shown in FIG. 2a, can involve a conductor track which is wound in the form of a flat coil. The conductor track can for example form an antenna for receiving high-frequency signals. The digital image 9 can be stored in a computer in the form of a digital data set.

FIG. 2b now shows a portion from FIG. 2a on an enlarged scale. The digital image 9 is formed from image points which can have the binary value ‘1’ or ‘0’, the electrically conductive structure 9f being formed from image points 9s of the binary value ‘1’. The other regions of the image 9 are formed from image points 9w of the binary value ‘0’. In the example shown in FIG. 2b circular image points 9s and 9w are arranged in a raster grid in such a way that the image points form columns and rows and adjacent image points have a common contact point. It can however also be provided that the image points are for example of an elliptical, square or rectangular configuration and/or that there is a spacing between adjacent image points.

The printer 10 is a printer having a rotating magnetisable printing drum 11 with a writing head 12 and an erasing head 13 to which a carrier film 16 is fed in a continuous roll-to-roll procedure. The carrier film 16 is pressed against the printing drum 11 with an impression roller 11a.

The carrier film can be for example a PET or POPP film of a thickness of between 10 μm and 50 μm, preferably of a thickness of between 19 μm and 23 μm. Layers can already be applied to the carrier film such as a release layer and a protective lacquer layer. The release and protective lacquer layers can preferably be of a thickness of between 0.2 and 1.2 μm. A multi-layer carrier film can have further layers such as decoration layers for producing optical effects and electrical functional layers, for example structured semiconductor polymer layers.

The writing head 12 of the printer 10 in the illustrated embodiment comprises magnetic heads 12k (see FIG. 3a) which are arranged in mutually juxtaposed relationship in a printing row and which can be actuated in image point-wise manner by an electronic control device (not shown in FIG. 1). The control device can be for example a computer with image processing and control software, in the memory of which the digital data set of the image line 9f (see FIGS. 2a and 2b) of the partially shaped electrically conductive structure is stored.

As diagrammatically shown in FIG. 3a the writing head 12 produces on the surface of the rotating printing drum 11 successive image lines which are formed from magnetic image points 11m, wherein the image points 9s and 9w identified hereinbefore in FIG. 2b provide the information as to which magnetic head 12k is actuated, that is to say has current flowing therethrough, and thus constitutes an actuated magnetic head 12k′. In that respect the actuated magnetic heads 12k′ are associated with the image points 9s involving the binary value ‘1’ while the non-actuated magnetic heads 12k are associated with the image points 9w involving the binary value ‘0’.

An actuated magnetic head 12k′ orients the elementary magnets, arranged in its region of influence, of the surface of the printing drum 11 along its magnetic field lines and thus produces a magnetic image point 11m which is able to attract magnetic particles, for example iron powder particles. The magnetic heads 12k and 12k′ are arranged at a spacing 12a which is the center-to-center spacing of the image points 11m. It is preferably provided that the image points 9s and 9w respectively (see FIG. 2b) also involve that center-to-center spacing, that is to say the resolution of the digital data set of the electrically conductive structure and the resolution of the printer are the same. In that way precisely one magnetic image point 11m is associated with each image point 9s (see FIG. 2b) and precisely one non-magnetic image point is associated with each image point 9w (see FIG. 2b). With magnetographic printers it is possible for example to achieve levels of resolution of 600 dpi, that is to say per inch (1 inch=25.4 mm) it is possible to represent 600 image points. With such a level of resolution the image points are arranged at a spacing of about 40 μm.

If the printing drum 11 is completely written to after a revolution the writing operation executed by the writing head 12 can be terminated. The latent magnetic image written on to the printing drum 11 can then be transferred repeatedly on to the carrier film 16 as described hereinafter.

The magnetic image points 11m can be erased again by means of the erasing head 13 in order to write a new item of image information on to the printing drum 11. The erasing head can put the elementary magnets of the printing drum 11 into a disordered position by means of high-frequency excitation so that the printing drum 11 is thereafter again non-magnetic.

It can however also be provided that the printing drum 11 is continuously written to with items of image information, that is to say in each revolution of the printing drum 11 the erasing head demagnetises the printing drum 11 in line-wise fashion and the writing head 12 thereafter writes an item of image information on to the printing drum 11 in line-wise fashion.

The latent magnetic image produced by the writing head 12 on the surface of the printing drum 11 is rendered visible in a developer unit 14 which is arranged downstream of the writing head 12 in the direction of rotation of the printing drum 11. The developer unit 14 has a supply container 14v, from the metering slot of which a magnetic dispersion 14d is applied to the surface of the printing drum 11, and a stripping device 14a arranged downstream of the metering slot. The magnetic dispersion 14d preferably involves spherical magnetic particles 14k which are bound in a dispersing agent 14b. The magnetic particles 14k have an electrically conductive surface. They can be of a diameter of between 2 and 10 μm, preferably between 2 and 4 μm. The core can be formed from iron, nickel-cobalt, an iron alloy or a magnetic ceramic while the conductive casing can be formed from iron, copper, nickel, gold, tin, zinc or an alloy of those substances. If the magnetic core is made of electrically conductive material it is possible to dispense with the electrically conductive casing. It is however also possible to provide that an electrically conductive core is produced with an electrically conductive casing of another material, for example to afford high conductivity or to produce special electrochemical properties. The dispersing agent 14b can preferably be in the form of a water-soluble dispersing agent.

With the above-specified particle diameters, when a printer resolution of 600 dpi is involved and with maximum sphere packing, between 4 and 20 magnetic particles can be arranged in mutually juxtaposed relationship per image point. Only 4 magnetic particles 14k per image point 11m are shown in FIGS. 3b through 3e, for greater clarity.

The magnetic dispersion 14d is so adjusted in terms of its viscosity that the magnetic particles 14k can be arranged on the image points 11m in optimum fashion, that is to say in a dense sphere packing, and in the regions which do not have any image points they can be removed from the printing drum 11 again by the stripping device 14a. It can be seen from FIG. 3b that thereafter it is only in the regions of the magnetic image points 11m that there are arranged magnetic particles 14k which are fixed in their position by the magnetic image points 11m and which now render visible the latent magnetic image stored in the surface of the printing drum 11.

The visible image produced by the magnetic dispersion 14d is now transferred on to the carrier film 16. For that purpose the carrier film is moved to the printing drum 11 downstream of the developer unit 14 in the direction of rotation of the printing drum 11 and pressed with the impression roller 11a against the printing drum 11. The magnetic dispersion 14d is so adjusted in terms of its adhesion properties that it preferably adheres to the carrier film 16 and can be detached without leaving any residue from the printing drum 11. For that purpose it can be provided that the impression roller 11a is heated and in that way the viscosity of the magnetic dispersion 14d is increased or the magnetic particles 14k are fixed on the carrier film by other suitable measures. By way of example the side of the carrier film 16 which is towards the printing drum 11 can be additionally coated with a primer, that is to say a bonding agent. FIG. 3c shows the carrier film 16 coated with the magnetic dispersion 14d prior to separation from the printing drum 11 while FIG. 3d shows it thereafter.

The printed carrier film 16 now passes through the washing station 20 in which the upper surface portions of the magnetic particles 14k are freed of the dispersing agent 14b. As this is preferably a water-soluble dispersing agent 14b it can be removed in an environmentally friendly fashion in a water bath. FIGS. 3e shows the coated carrier film 16 after leaving the washing station 20. The upper surface portions of the magnetic particles 14k are now exposed and project out of the dispersing agent 14b.

In the following drying station 30 which in the illustrated embodiment has a lamp 301 which emits thermal and/or UV radiation the dispersing agent 14b is now hardened. In that way the magnetic particles 14k are fixed on the carrier film 16. The hardening procedure can involve a crosslinking reaction in respect of the dispersing agent 14b, which is triggered by UV radiation. By way of example water-soluble polymers can be hardened in that fashion.

Finally the carrier film 16 passes through the galvanic bath 40. There it can be provided that, in a first process step, a first electrically conductive layer 14m is deposited on the magnetic particles 14k by a chemical reaction without external current. This can involve a copper layer or a silver layer which can be particularly well deposited with such a process.

It is advantageously provided that the electrically conductive layer 14m involves a layer thickness of between 40 nm and 70 nm. A copper sulfate bath of the following composition can be used as the reactant:

| Constituent | Proportion |
|---|---|
| Copper (II) sulfate 5-hydrate | 160-240 g/l = 40-60 g/l Cu |
| Sulfuric acid | 40-100 g/l |
| Chloride (for example in the form of | 30-150 mg/l |
| sodium chloride) | |

The electrically conductive layer 14m which is deposited without external current can now be reinforced by galvanisation with an external current with a second electrically conductive layer 14m′ for example to improve conductivity and/or mechanical strength. The second layer 14m′ can be a layer consisting of the metal of the first layer 14m. It is however also possible to provide a different metal. By way of example silver or gold can be used for the first layer 14m′ in order to afford particularly good conductivity or resistance to corrosion. The current density can preferably be set at up to 5 A/dm². FIG. 3f shows the finished carrier film 16 with the two layers 14m and 14m′.

The carrier film 16 can be neutralised and dried in the post-treatment station 50. Neutralisation can be effected by a washing operation which removes the residues of the galvanic bath. For that purpose it is possible to implement flushing and the use of organic acids.

It is possible to involve further manufacturing steps in order to apply further layers to the carrier film 16 and/or to structure layers. As already stated hereinbefore the carrier film 16 can already be a multi-layer film which, besides conductive structures, has further functional and/or decorative layers. The partially shaped metallic layer applied as described hereinbefore can be for example conductor tracks which interconnect organic semiconductor structures and which are embedded in decorative regions which for example are in the form of optically active diffractive structures.

FIG. 4 now shows a magnetographic manufacturing station in which a magnetisable circulating printing belt 111 is provided as the printing form. The manufacturing station 2 is formed from a magnetographic printer 110, the drying station 30 and the galvanic bath 40.

Production of the latent magnetic image on the surface of the printing belt 111 is effected as described hereinbefore with reference to FIG. 1. FIG. 5a shows the configuration of the magnetic image points 11m in the printing belt 111 in the same manner as described hereinbefore in the printing drum 11 (FIG. 3a).

The carrier film 16 is now coated with a primer 16p and is fed to the printer 110 by a roll-to-roll process. In that operation it is pressed with the impression rollers 11a against the continuously circulating printing belt 111 which is driven by means of transport rollers lit. Such an arrangement produces surface contact between the printing belt 111 and the carrier film 16, with the printing belt 111 and the carrier film 16 being at rest relative to each other.

The primer can be an epoxy resin, acrylic resin or radiation-crosslinkable lacquer which is applied in a layer thickness of between 3 and 9 mm, preferably in a layer thickness which is between 0.5 times and 1.5 times the mean diameter of the magnetic particles, preferably between 0.5 times and 0.8 times. The glass transition temperature of the thermoplastic polymer which is to be selected in dependence on the material of the magnetic particle enclosure can be used for the selection of a suitable polymer.

In the embodiment shown in FIG. 4 the side of the carrier film 16 which is not coated with primer faces towards the printing belt 111 and the developer unit 14 is in contact with the primer 16p which has been applied to the carrier film 16.

The supply container 14v of the developer unit 14 is filled in this embodiment with a magnetic powder 14p comprising magnetic particles 14k. Although with this arrangement the magnetic particles 14k do not come into direct contact with the surface of the printing belt 111 because the carrier film 16 and the primer 16p are arranged therebetween, the small thickness of the carrier film 16 and the primer layer means that no losses in terms of quality are to be observed in the development of the latent magnetic image. The carrier film 16 can therefore also be a carrier film which, as described hereinbefore, has further additional layers.

Excess magnetic particles are now removed from the surface of the primer 16p by a suction removal device 14a′. FIG. 5b shows the carrier film 16 with the primer 16p, which is arranged on the printing belt 111, and the magnetic particles 14k arranged on the surface of the primer 16p with a perpendicular spacing relative to the magnetic image points 11m.

The impression rollers 11a which are arranged in mutually superposed relationship downstream of the suction removal device 14a′ now press the magnetic particles 14k into the surface of the primer 16p (see FIG. 5c). The movement by which the magnetic particles 14k sink into the primer can be promoted for example by heating the impression rollers 11a. The magnetic particles 14k are then permanently fixed on the carrier film 16 in the drying station 30. In the embodiment shown in FIG. 4 the drying station 30 is arranged downstream of the printing belt 111. UV radiation or thermal radiation produced by the lamp 301 dries the primer and/or hardens it, as already described with reference to FIG. 1 using the example of the dispersing agent 14d.

If the lamp 301 is a heating lamp which dries the primer by thermal radiation the arrangement shown in FIG. 4 of the drying station 30 downstream of the printing belt 111 can be particularly advantageous as the magnetisation of the printing belt 111 can be attenuated by heating.

It can also be provided that the embodiment shown in FIG. 4 is modified in such a way that, after the excess particles have been removed by suction, in an additional working station which is not shown in FIG. 4, the primer 16b is subjected to initial dissolution and/or is softened to such an extent that the magnetic particles 14k sink into the surface of the primer as a result. It can further be provided that the drying station 30 is provided instead of the two mutually oppositely disposed impression rollers 11a and the above-mentioned additional working station is arranged between the suction removal device 14a′ and the drying station 30.

Finally the carrier film 16 passes through the two-stage galvanic bath 40 in which firstly the electrically conductive layer 14m is deposited on the magnetic particles 14k in an external current-less operation and thereafter the metallic layer 14m′ is applied using external current.

FIG. 5d shows the finished carrier film 16 with the primer layer 16p and the magnetic particles 14k which are covered over with the layers 14m and 14m′.

FIG. 6 now shows a third embodiment with a manufacturing station 3 which differs from the manufacturing station 2 described hereinbefore with reference to FIG. 3, essentially in the nature of the carrier film 16 to be printed upon. In that respect FIGS. 7a through 7e show the results of the individual manufacturing steps in the form of diagrammatic sectional views.

The manufacturing station 3 includes a magnetographic printer 210, the drying station 30 and the galvanic bath 40. Like the printer 110 described hereinbefore the printer 210 has a circulating printing belt 211. As FIG. 7a shows magnetic image points 11m can be produced in the printing belt 211.

FIG. 7b now shows the carrier film 16 which is already coated with the primer 16p and the magnetic dispersion 14d, in contact with the printing belt 211. In this case the magnetic particles 14k bound in the magnetic dispersion 14d are preferably arranged in a single layer in a dense sphere packing in a dispersing agent which can be washed off. The layer thickness of the adhesion layer formed from the primer and the magnetic dispersion is between about 1*d and 1.5*d, preferably between 1.2*d and 1.4*d, wherein d denotes the mean diameter of the magnetic particle 14k. As can be seen from FIG. 7b firstly magnetic particles 14k are also arranged in the regions of the printing belt 211, in which no magnetic image points are formed. Excess magnetic particles 14k are now removed in a developer unit 214 arranged at the printer 210. The developer unit 214 is provided with a washing station 214w and a suction removal device 214a.

When the carrier film 16 coated with the primer 16p and the magnetic dispersion 14d passes through the developer unit 214 the dispersing agent of the magnetic dispersion 14d is now firstly removed in the washing station 214w so that the magnetic particles 14k are only still fixed in their position in the regions of the magnetic image points 11m by magnetic force. The suction removal device 214a which is arranged downstream of the washing station 214w can now remove the magnetic particles which are disposed outside the magnetic image points 11m. FIG. 6c shows the developed carrier film 16 in which magnetic particles 14k are only still present in the regions of the magnetic image points 11m.

The magnetic particles 14k are now fixed on the carrier film 16 in a fixing station 530 which is disposed in a downstream position. The fixing station 530 includes a through-passage bath 530b and a drier 530t. The primer 16p is subjected to surface dissolution by a solvent in the bath 530b so that the magnetic particles 14k sink into the surface of the primer 16p. It can also be provided that a hardener is applied, which with the primer forms a hardenable layer. Hardening of the layer or of the primer with its dissolved surface can be effected by thermal or UV radiation. For that purpose the drier 530t which is arranged downstream of the bath 530b has a lamp 530l which in the embodiment illustrated in FIG. 6 is arranged over the surface of the carrier film 16, which is remote from the printing belt 111.

In regard to the galvanic bath 40 arranged after the fixing station 530 and the post-processing station 50, attention is directed to the description relating to FIGS. 1 and 4.

FIG. 7e shows the finished carrier film 16 with the primer layer 16p and the magnetic particles 14k which are covered over with the layers 14m and 14m′. Because it is provided that the layer of magnetic particles 14k, which is applied with a highly productive printing process, is to be galvanically reinforced in a roll-to-roll process, partially shaped electrically conductive structures can be produced in that way, which can be particularly advantageously adapted to functional requirements in terms of dimensions, choice of material and layer thickness.

The above-described embodiments include partial solutions which can be combined to afford further solutions according to the invention. By way of example, the printing drum can be replaced by the printing belt or vice-versa without thereby departing from the principle of the solution involved. FIG. 1 involves line contact between the carrier film 16 and the printing drum 11. It is however also possible to implement surface contact, as is provided in the other two embodiments shown in FIGS. 4 and 6, by the carrier belt 16 extending around a peripheral portion of the printing drum 11.

Further variations in the solution according to the invention are afforded for example by different coating on the carrier film 16. The carrier film 16 can already be provided with layers which for example produce optical effects. The arrangement however may also have electrically functional layers having regions which are to be electrically conductingly connected together by the process according to the invention. It can however also be provided that further layers are applied to the carrier film, subsequently to the application of the electrically conducting structure.

All solutions are distinguished by a high level of flexibility, a high processing speed, wear-free continuous and inexpensive operation, with a uniform high quality for the end product.

1. A process for the production of a partially shaped electrically conductive structure on a carrier substrate, wherein
a latent magnetic image of the graphic form of the electrically conductive structure, which latent magnetic image is formed from magnetic image points and non-magnetic image points, is produced from a digital data set which defines the graphic form of the electrically conductive structure on a magnetisable printing form, and wherein, by means of the printing form, magnetic particles having an electrically conductive surface, which are attracted by the magnetic image points, are arranged by the latent magnetic image to afford the graphic form of the electrically conductive structure on the carrier substrate and are fixed there, and wherein an electrically conductive layer is galvanically applied to the magnetic particles.

2. A process as set forth in claim 1, wherein magnetic particles of a diameter of between 2 μm and 10 μm are used.

3. (canceled)

4. A process as set forth in claim 1, wherein the magnetic particles are connected together by means of a first electrically conductive layer which is applied in the form of a metallic layer galvanically without external current using a reducing agent

5. A process as set forth in claim 4 wherein a second electrically conductive layer is galvanically deposited on the magnetic particles or the first electrically conductive layer.

6. A process as set forth in claim 1, wherein the carrier substrate is coated prior to the application of the magnetic particles with a primer.

7. A process as set forth in claim 1, wherein the magnetic particles are applied in the form of powder.

8. A process as set forth in claim 1, wherein the magnetic particles are applied in the form of a disperse phase of a dispersion, wherein the proportion of the disperse phase (14b) to the dispersion (14d) is set to between 2 and 10% by weight.

9. A process as set forth in claim 6, wherein a dispersing agent is used, which causes initial dissolution of the primer.

10. A process as set forth in claim 6, wherein the magnetic particles are fixed on the carrier substrate by removal of the solvent from the primer and/or the dispersing agent.

11. A process as set forth in claim 6, wherein the magnetic particles are fixed on the carrier substrate by melting of the primer and/or the dispersing agent.

12. A process as set forth in claim 6, wherein the magnetic particles are fixed on the carrier substrate by hardening of the primer and/or the dispersing agent by UV radiation or thermally.

13. A process as set forth in claim 6, wherein the primer and/or the dispersing agent forms or form an adhesion layer with a layer thickness which is between 0.5 times and 1.5 times the mean diameter of the magnetic particles.

14. A process as set forth in claim 1, wherein the upper portions of the magnetic particles are exposed prior to the application of the first electrically conductive layer and/or the second electrically conductive layer.

15. A process as set forth in claim 14, wherein to expose the upper portions of the magnetic particles, a solvent is used, which provides for initial dissolution of the primer and/or the dispersing agent.

16. A process as set forth in claim 14, wherein the upper portions of the magnetic particles are exposed by partial thermal removal of the primer and/or the dispersing agent.

17. A process as set forth in claim 1, wherein the magnetic particles are applied to the magnetisable printing form and are transferred from there on to the carrier substrate.

18. A process as set forth in claim 1, wherein the magnetic particles are applied to the carrier substrate and the printing form with the latent magnetic image is arranged on the side of the carrier substrate which is in opposite relationship to the magnetic particles applied to the carrier substrate.

19. (canceled)

20. (canceled)

21. (canceled)

22. (canceled)

23. A multi-layer body having a partially shaped electrically conductive structure, wherein
the multi-layer body has a layer of magnetic particles having an electrically conductive surface, which are arranged in the graphic form of the electrically conductive structure, and wherein the magnetic particles are connected together by means of a first electrically conductive layer.

24. A multi-layer body as set forth in claim 23, wherein the first electrically conductive layer is of a thickness of between 40 nm and 70 nm.

25. (canceled)

26. A multi-layer body as set forth in claim 23, wherein the multi-layer body has a second electrically conductive layer which is in the form of an electrical functional layer and which is galvanically applied to the magnetic particles and/or the first electrically conductive layer and which is of a layer thickness of between 2 μm and 50 μm.

27. A multi-layer body as set forth in claim 26, wherein the second electrically conductive layer comprises a metal with a low specific resistance selected from the group consisting of as aluminum, copper, nickel, silver and gold.

28. A multi-layer body as set forth in the magnetic particles are of a flake configuration.

29. A multi-layer body as set forth in claim 23, wherein the magnetic particles are embedded in an adhesion layer which is of a layer thickness which is between 50% and 80% of the mean diameter of the magnetic particles.

30. A multi-layer body as set forth in claim 29, wherein the magnetic particles project out of the adhesion layer by between 5% and 95% of their mean diameter.

31. A multi-layer body as set forth in claim 23, wherein the magnetic particles are formed from a soft-magnetic core and an electrically conducting casing, selected from the group consisting of iron, copper, nickel, gold, tin, zinc and alloys thereof.
